(19) United States
(12) Patent Application Publication
(10) Pub. No.: US 2001/0016917 A1
(43) Pub. Date: Aug. 23, 2001

(54) Method and configuration for supplying a clock signal to processor-controlled apparatuses

(76) Inventor: Soren Haubold, Munchen (DE)

Correspondence Address: LERNER AND GREENBERG P.A, Post Office Box 2480, Hollywood, FL, 33022-2480, US

(21) Appl. No.: 09/783,515

(22) Filed: Feb. 14, 2001

Related U.S. Application Data
(63) Continuation of application No. PCT/DE99/02388, filed on Aug. 2, 1999.

(30) Foreign Application Priority Data
Aug. 14, 1998 (DE) 198 36 956.5

(51) Int. Cl. G06F 1/26; G06F 1/28; G06F 1/30

(52) U.S. Cl. 713/322

(57) ABSTRACT

A method and a configuration are provided for supplying a clock signal to processor-controlled apparatuses. At certain times of no processor load or low processor load, a low clock frequency is fed to a processor device of a processor-controlled apparatus. The low clock frequency is generated by the same quartz as a clock frequency which is fed to a real-time clock of the processor-controlled apparatus.

### CROSS-REFERENCE TO RELATED APPLICATION

This application is a continuation of copending International Application No. PCT/DE99/02388, filed Aug. 2, 1999, which designated the United States.

### BACKGROUND OF THE INVENTION

### Field of the Invention

The invention relates to a method and a configuration for supplying a clock signal to processor-controlled apparatuses, in particular mobile or portable apparatuses, for example mobile radio phones or portable computers.

Power consumption plays an important role in mobile processor-controlled apparatuses, for example mobile radio phones or portable computers. Throughout the world, immense efforts are being made to keep the power drain of apparatuses as low as possible while maintaining, in particular, a standby mode.

A generally known measure for saving power resides in temporarily reducing or switching off the supply voltage of unused components through the use of a control device in the apparatus. A receiver unit and a transmitter unit in mobile radio phones or a hard disk and a screen in portable computers are examples of components which can be switched off by a control device when the supply voltage is not used, and can be switched on again for use during operation.

Usually, the control device for switching certain functional modules on and off is clock-controlled. In addition, increasing numbers of processor-controlled apparatuses have a real-time clock to which a clock frequency of 32.768 kHz of a so-called clock quartz is fed.

### SUMMARY OF THE INVENTION

It is accordingly an object of the invention to provide a method and a configuration for supplying a clock signal to processor-controlled apparatuses, which overcome the hereinafore-mentioned disadvantages of the heretofore-known methods and configurations of this general type and with which an apparatus can be operated in a power-saving manner with little expenditure.

With the foregoing and other objects in view there is provided, in accordance with the invention, a method for supplying a clock signal to processor-controlled apparatuses, which comprises basing a clock frequency fed to a device for determining a clock time and a clock frequency fed to a processor device at times of no processor load or low processor load, on a quartz frequency of the same quartz. The processor device is clocked with a system clock in third times.

With the objects of the invention in view, there is also provided a configuration for supplying a clock signal to processor-controlled apparatuses, comprising a clock selector unit connected to a processor device for selecting a frequency to be fed to the processor device, as a function of a processor load. A quartz is provided for generating a quartz frequency and for feeding a clock frequency based on the quartz frequency or a frequency derived therefrom to a device for determining the clock time. The clock selector unit feeds a clock frequency based on the quartz frequency or on a frequency derived therefrom to the processor device in first times of no processor load or low processor load. The processor device is clocked with a system clock in third times.

The invention is therefore based on the concept of feeding different clock frequencies to the processor device as a function of the processor load, the real-time clock and the processor device being clocked at certain times through the use of the same quartz.

This ensures that the power consumption of the processor device can be adapted to the computing power of the processor at that moment. The processor can thus be operated at certain times of low processor load or no processor load with a low power consumption without requiring an additional quartz.

In particular, if the quartz is a so-called clock quartz which oscillates with an integral fraction or an integral multiple of 32.768 kHz, the simultaneous use of a quartz for clocking a real-time clock and a processor device is particularly advantageous.

One refinement of the invention provides for a selection of a clock frequency which has to be fed to the processor device and which is lower than the current clock frequency, to be initiated by the processor device itself.

Other developments of the invention provide different possible ways of selecting a clock frequency which is to be fed to the processor device and which is higher than the current clock frequency fed to the processor device.

In order to reduce the power consumption further, it is possible to at least temporarily switch off components of the apparatus which are not required, as a function of the clock frequency fed to the processor device.

Other features which are considered as characteristic for the invention are set forth in the appended claims.

Although the invention is illustrated and described herein as embodied in a method and a configuration for supplying a clock signal to processor-controlled apparatuses, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of a clock supply system;

FIG. 2 is a schematic diagram of a sequence control system; and

FIG. 3 is a block circuit diagram of a mobile radio phone.

### DESCRIPTION OF THE PREFERRED EMBODIMENTS

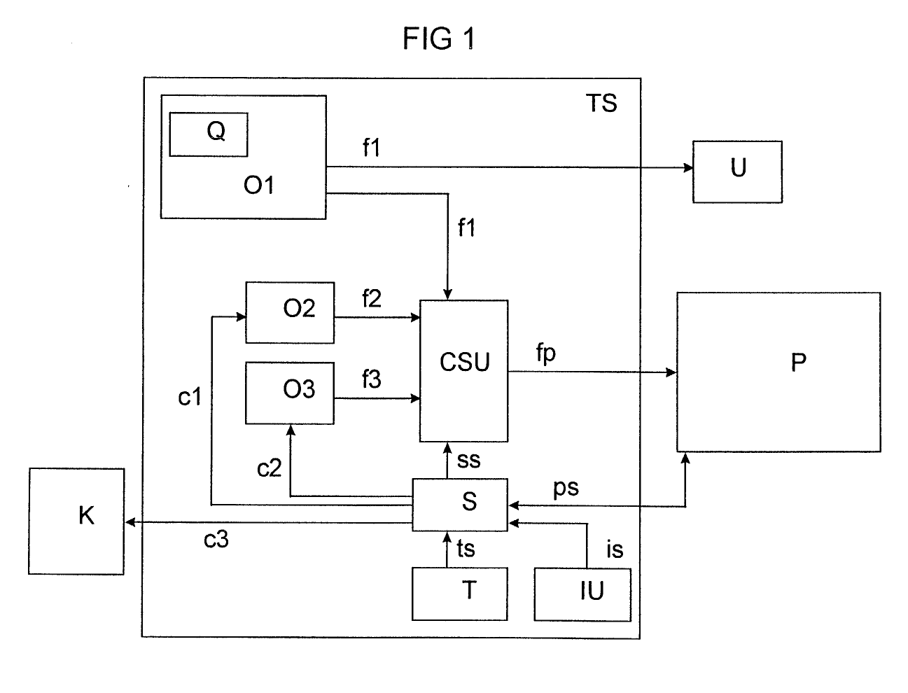

Referring now to the figures of the drawings in detail and first, particularly, to FIG. 1 thereof, there is seen a clock supply system TS for a processor-controlled apparatus. In this case, the apparatus may contain one or more processor devices P, for example a digital signal processor and/or a microcontroller.

A clock quartz Q generates a quartz frequency of 32.768 kHz or an integral multiple or an integral fraction of this frequency. Sinusoidal oscillations generated by the clock quartz are converted by an oscillator circuit O1 into square-wave signals of the same frequency. This clock signal with the quartz frequency is fed directly, or if appropriate indirectly after clock conditioning, clock multiplication or clock division, to a real-time clock (or a device for determining a clock time) Nu as a clock signal with a frequency f1. In addition, the clock signal with the quartz frequency is fed directly, or if appropriate indirectly after clock conditioning, clock multiplication or clock division, to a clock selector unit CSU. In the exemplary embodiment described herein, the same frequency f1 is fed to the clock selector unit CSU and to the real-time clock U.

In addition, a standby clock f2 of 1.625 mHz generated by an oscillator O2 and a system clock f3 of 13 or 26 MHz generated by an oscillator O3, which can also be fed to a high-frequency section of a radio device, are fed to the clock selector unit CSU.

A clock frequency fp is selected from the available frequencies f1, f2 or f3 by the clock selector unit CSU as a function of a processor load, and is fed to the processor P, permitting the processor to operate in accordance with its usage factor.

The clock selector device CSU is controlled, and thus the clock is selected, through the use of control signals ss which are transmitted to the clock selector device CSU by a sequence controller unit S.

The sequence control can be carried out in this case as a function of different criteria:

the sequence control can be influenced by the processor P itself by transmitting processor control signals ps;

the sequence control can be influenced through the use of interrupt control signals is from an interrupt unit IU which, for example, is also clocked with a low clock through the use of the clock quartz, if external events, such as a keyboard entry or an insertion of a SIM module (user identifying module), so require; and

the sequence control can be influenced through the use of timer control signals ts which are transmitted to the sequence controller unit S through the use of a timer T after expiration of a certain time period.

In addition to controlling the clock selector unit CSU, the sequence controller unit S is also responsible for transmitting switch-on and switch-off signals c1, c2, c3. The oscillator O2 for generating the standby clock, the oscillator O3 for generating the system clock or other components K of the processor-controlled apparatus, such as an amplifier or other elements of a radio-frequency section HF of a mobile radio phone, can be switched off at times when it is not necessary for them to operate, and switched on again at times when it is necessary for them to operate, through the use of the signals c1, c2, c3. This depends in particular on the operating state which the processor-controlled apparatus is in at a particular time. Thus, in mobile radio phones FG it is possible to distinguish between a ready-to-receive operating state and a communications state. The processor has an appreciable usage factor in only 5% of the time, namely in phases of reception of paging blocks, in the ready-to-receive state. As a result, the ready-to-receive operating state can be divided into two further operating states: reception of paging blocks and no reception of paging blocks.

In one development of the invention which has a processor device P that can be switched to a completely clockless state, at times of no processor load it is possible to switch the processor P to a clockless state instead of clocking it with a frequency f1 based on the clock quartz. Nevertheless, in order to be able to start processing when external events occur, those events are detected by an external interrupt unit IU which is clocked with a low clock, for example a clock based on the clock quartz, even at times when the processor device P is switched to a clockless state.

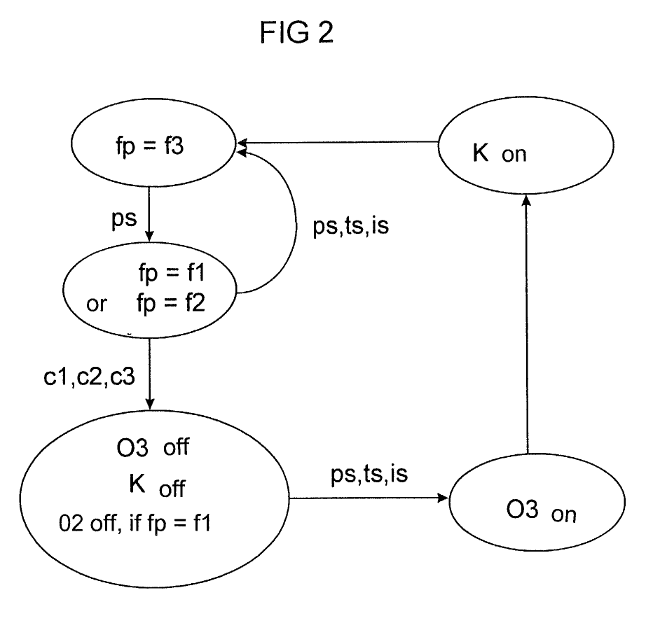

FIG. 2 shows an example of a sequence diagram of a clock supply of a processor-controlled apparatus:

The apparatus is initially in a basic state in which a processor device P is clocked with a frequency fp=f3. As a result of processor control signals ps being transmitted from the processor device P to the sequence controller unit S, the processor device P is clocked with a frequency fp=f1 or fp=f2 after the transmission of the appropriate control signals ss from the sequence controller unit S to the clock selector device CSU.

As a result of the transmission of switch-off signals c2, c1, c3 from the sequence controller unit S to the oscillator O3, to the oscillator O2 (if fp=f1) or to the other components K of the apparatus which are to be switched off, the oscillator O3, the oscillator O2 (if fp=f1) or the other components K of the apparatus which are to be switched off are switched off: O3 off, K off, O2 off, if fp=f1.

As a result of the transmission of processor control signals ps, interrupt control signals is and timer control signals ts from the respective units to the sequence controller unit S, the oscillator O3 is switched on again: O3 on.

As a result of the transmission of processor control signals ps, interrupt control signals is and timer control signals ts from the respective units to the sequence controller unit S, the previously switched-off components K of the apparatus are switched on again (K on) through the use of switch-on signals c3, and the apparatus is finally returned to the basic state.

Therefore, a low clock frequency is fed to the processor device of a processor-controlled apparatus at certain times of no processor load or low processor load (depending on the embodiment variant). The low clock frequency is generated by the same quartz as a clock frequency which is fed to a real-time clock of the processor-controlled apparatus.

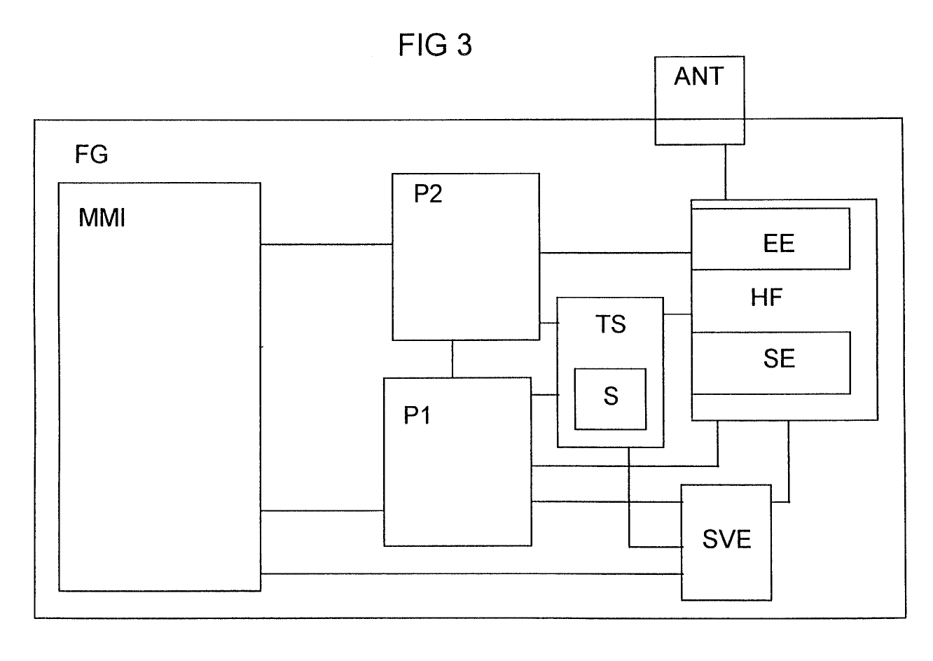

FIG. 3 shows a mobile radio phone FG including an operator unit MMI, a control unit P1 and a processing device P2, a power supply device SVE, a clock supply system TS, and a high-frequency section HF composed of a receiver device EE, a transmitter device SE, a frequency synthesizer and an antenna device ANT. The individual elements of the mobile radio phone are also connected to one another through the use of conductor tracks, cable systems or bus systems.

The control device P1 is composed essentially of a program-controlled microcontroller, and the processing device P2 of a digital signal processor, both being able to access memory modules to perform writing and reading.

The microcontroller P1 controls and monitors all of the central elements and functions of the mobile radio device FG and essentially controls communications and signaling operations, together with the sequence controller unit S. The switching on and off of certain components of the radio-frequency section HF can be controlled through the use of the control device P1, the sequence controller unit S and/or the clock supply system TS. In addition, the system clock signal f3 generated in the clock supply system can be fed to the radio-frequency section HF and/or the respective frequency synthesizer.

I claim:

1. A method for supplying a clock signal to processor-controlled apparatuses, which comprises:
basing a clock frequency fed to a device for determining a clock time and a clock frequency fed to a processor device at times of no processor load or low processor load, on a quartz frequency of the same quartz; and
clocking the processor device with a system clock in third times.

2. The method according to claim 1, which further comprises:
feeding a first clock frequency based on a first quartz frequency or a frequency derived therefrom, to the device for determining a clock time;
selecting the clock frequency to be fed to the processor device as a function of the processor load; and
feeding the clock frequency based on the first quartz frequency or on a frequency derived therefrom, to the processor device in first times of no processor load or low processor load.

3. The method according to claim 1, which further comprises generating the quartz frequency with a clock quartz.

4. The method according to claim 1, which further comprises switching the processor device to a clockless state in second times of no processor load.

5. The method according to claim 1, which further comprises clocking the processor device with a reduced frequency in fourth times of low processor load, the reduced frequency being lower than the frequency of the system clock and higher than the quartz frequency or the frequency derived therefrom.

6. The method according to claim 1, which further comprises initiating, with the processor device, a selection of a clock frequency to be fed to the processor device, being lower than a current frequency fed to the processor device.

7. The method according to claim 1, which further comprises initiating, with the processor device, a selection of a clock frequency to be fed to the processor device, being higher than a current clock frequency fed to the processor device.

8. The method according to claim 1, which further comprises initiating, with external events, a selection of a clock frequency to be fed to the processor device, being higher than a current clock frequency fed to the processor device.

9. The method according to claim 1, which further comprises initiating, after expiration of a predefined time period, a selection of a clock frequency to be fed to the processor device, being higher than a current clock frequency fed to the processor device.

10. The method according to claim 1, which further comprises temporarily switching off not-required components of an apparatus as a function of the clock frequency fed to the processor device.

11. In a configuration for supplying a clock signal to processor-controlled apparatuses having a processor device and associated with a device for determining a clock time, the improvement comprising:
a clock selector unit connected to the processor device for selecting a frequency to be fed to the processor device, as a function of a processor load;
a quartz for generating a quartz frequency and for feeding a clock frequency based on the quartz frequency or a frequency derived therefrom to the device for determining the clock time;
said clock selector unit feeding a clock frequency based on the quartz frequency or on a frequency derived therefrom to the processor device in first times of no processor load or low processor load; and
the processor device clocked with a system clock in third times.
